(19) United States
(12) Patent Application Publication
(10) Pub. No.: US 2018/0232743 A1
(43) Pub. Date: Aug. 16, 2018

(54) ONLINE COLLECTABLE COMMERCE PLATFORM USING ONLINE EXHIBITION ROOM AND METHOD FOR OPERATING THE SAME

(71) Applicant: Dong Wook KIM, Seoul (KR)

(72) Inventor: Dong Wook KIM, Seoul (KR)

(21) Appl. No.: 15/587,855

(22) Filed: May 5, 2017

(30) Foreign Application Priority Data
Feb. 16, 2017 (KR) 10-2017-0020793

(51) Int. Cl. G06Q 30/00; G06Q 30/08; G06Q 30/06

(52) U.S. Cl. CPC G06Q 30/018; G06Q 30/0623; G06Q 30/08

(57) ABSTRACT

Disclosed is an online collectable commerce platform comprising an online exhibition room providing unit configured to provide an online exhibition room to a producer user or a collector user for an exhibition of collectables, a collectable trading intermediate unit configured to provide another user with information about at least one collectable for sale among the collectables exhibited in the online exhibition room and intermediate a trade of the at least one collectable for sale between a plurality of users, a user information management unit configured to store information about one or more users and switch a type of a normal user to the collector user when the normal user purchases the collectable for sale, and a collectable information management unit configured to store information about one or more collectables and manage curation information and transaction history information for each collectable.

### CROSS-REFERENCE TO RELATED APPLICATIONS

A claim for priority under 35 U.S.C. § 119 is made to Korean Patent Application No. 10-2017-0020793 filed Feb. 16, 2017, in the Korean Intellectual Property Office, the entire contents of which are hereby incorporated by reference.

### BACKGROUND

Embodiments of the inventive concept described herein relate to an online collectable commerce platform using an online exhibition room and a method for operating the online collectable commerce platform.

In general, artworks are exhibited in a gallery, and a buyer who viewed the exhibited artworks purchases an artwork from an artist through the gallery. Since the size and the number of the galleries are limited, the number of artworks displayed in the gallery is very small compared to the total number of the artworks. A considerable number of artworks has been kept at artist's studio with little chance of exhibition. A potential buyer wants to find an artist who creates an artwork of the buyer's preferred genre or a collector who owns such an artwork. However, since information on the artworks and the galleries are limited, there are many difficulties in finding such an artist or collector. In addition, although there are lots of relatively low-priced artworks that are created by new artists or artworks that serve a utilitarian purpose, a current mainstream artwork market mainly deals in high-priced artworks in a specific genre with high scarcity. Thus, transactions of the low-priced artworks in a variety of genres are not active.

The above-described problem is not limited to the artworks. Other than the artworks, various collectables, such as, books, records, antiques, stamps, money, tickets, figures, sneakers, wines, have limited chances of being traded or exhibited. Even though there are some online malls and second hand goods platforms for the collectables, they do not provide a separate and long lasting exhibition space. Also, when the potential buyer tries to find the collectable that he/she wants or the collector who owns the collectable, it is a lot more difficult for the potential buyer to find the collectable or the collector who owns the collectable than to find the artwork or the collector who owns the artwork. In addition, it is quite troublesome for the collector to register his/her own collectibles for sale every time on a seller's page.

### SUMMARY

Embodiments of the inventive concept provide an online collectable commerce platform using an online exhibition room and a method of operating the online collectable commerce platform.

According to an aspect of an embodiment, an online collectable commerce platform comprises a user interface unit configured to be connected to a user terminal through a network and to transmit and receive predetermined information to and from the user terminal, an online exhibition room providing unit configured to provide an online exhibition room to a producer user or a collector user for an exhibition of collectables owned by the producer user or the collector user in the online exhibition room, a collectable trading intermediate unit configured to provide another user with information about at least one collectable for sale among the collectables exhibited in the online exhibition room and intermediate a trade of the at least one collectable for sale between a plurality of users, a user information management unit configured to store information about one or more users, manage the users after classifying a type of the users into a normal user, the producer user, and the collector user, and switch the type of the normal user to the collector user when the normal user purchases the collectable for sale, and a collectable information management unit configured to store information about one or more collectables and manage curation information and transaction history information for each collectable as the information about the collectables, wherein the collectable for sale, which is purchased by the collector user from another user, is exhibited in the online exhibition room, the information about the collectable for sale are provided to another user, and a resale of the collectable for sale is intermediated between the collector user and another user.

According to another aspect of an embodiment, a method of operating an online collectable commerce platform, which is connected to a user terminal through a network to transmit and receive predetermined information to and from the user terminal, comprises providing an online exhibition room to a producer user or a collector user for an exhibition of collectables owned by the producer user or the collector user in the online exhibition room, providing another user with information about at least one collectable for sale among the collectables exhibited in the online exhibition room and intermediate a trade of the at least one collectable for sale between a plurality of users, storing information about one or more users and managing the users after classifying a type of the users into a normal user, the producer user, and the collector user to switch the type of the normal user to the collector user when the normal user purchases the collectable for sale, and storing information about one or more collectables to manage curation information and transaction history information for each collectable as the information about the collectables, wherein the collectable for sale, which is purchased by the collector user from another user, is exhibited in the online exhibition room, the information about the collectable for sale are provided to another user, and a resale of the collectable for sale is intermediated between the collector user and another user.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram showing an online collectable commerce system according to an exemplary embodiment of the present disclosure;

FIG. 2 is a block diagram showing a configuration of an online collectable commerce platform system of FIG. 1;

FIG. 3 is a flowchart showing a method for operating an online collectable commerce platform of FIG. 1;

FIG. 4 is a flowchart showing a method for authenticating a collectable traded in offline markets using a collectable authentication certificate having a unique identifier as a detailed configuration of an operation of authenticating the collectable of FIG. 3;

FIG. 5 is a flowchart showing a method for associating information about a collectable with an online exhibition room as a detailed configuration of an operation of managing the collectable information of FIG. 3;

FIG. 6 is a flowchart showing a method for determining a variable for auction collectables as a detailed configuration of the operation of managing the collectable information of FIG. 3; and

FIG. 7 is a graph showing a number of exhibition rooms, which exponentially increases, as a function of a time.

### DETAILED DESCRIPTION

Reference will now be made in detail to exemplary embodiments, examples of which are illustrated in the accompanying drawings. However, the present inventive concept may be embodied in many different forms and should not be construed as being limited to the exemplary embodiments set forth herein. Rather, these exemplary embodiments are provided so that the present disclosure will be thorough and complete, and will fully convey the scope of the present inventive concept to those skilled in the art, and the spirit and scope of the present inventive concept should be defined by the appended claims.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

Hereinafter, the present invention will be explained in detail with reference to the accompanying drawings.

In the following descriptions, a term “collectable” used herein indicates arbitrary objects of interest to a collector that are capable of being exhibited and traded, such as artworks, books, records, antiques, stamps, money, tickets, figures, sneakers, wines, etc.

In the following descriptions, a term “producer” used herein indicates not only a producer who produces the collection objects, but also a creator who creates the collection objects.

In the following descriptions, a term “online exhibition” will be used to mean an exhibition in which the collectable is posted online to allow a user to view the collectable without time and space constraints. In the following descriptions, a term “online exhibition room” used herein indicates an online virtual space for the online exhibition.

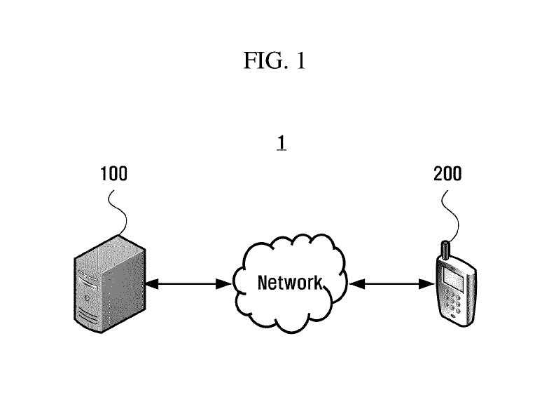

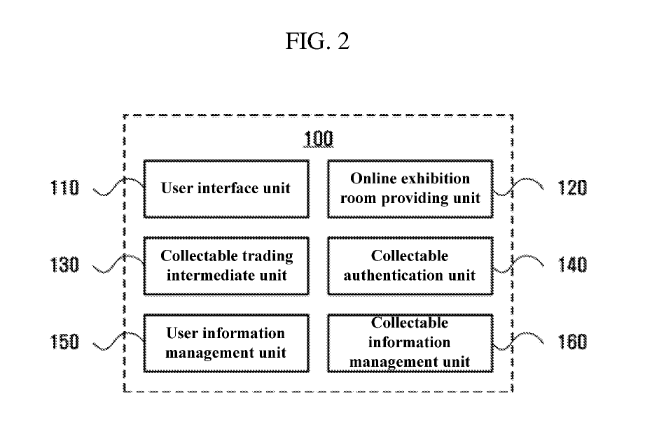

FIG. 1 is a block diagram showing an online collectable commerce system 1 according to an exemplary embodiment of the present disclosure, and FIG. 2 is a block diagram showing a configuration of an online collectable commerce platform 100 of FIG. 1.

Referring to FIG. 1, the online collectable commerce system 1 includes the online collectable commerce platform 100 and a user terminal 200.

The online collectable commerce platform 100 and the user terminal 200 are connected to each other through a network. The network includes a wired network, a wireless network, or a combination thereof. The online collectable commerce platform 100 and the user terminal 200 may transmit and receive information through the network.

The online collectable commerce platform 100 provides a user with an online exhibition room and provides other users with information about the collectables exhibited in the online exhibition room. The online collectable commerce platform 100 may intermediate a trade of the collectables between the users through the online exhibition room. The trade of the collectables may be provided at a fixed price or by an auction, but it should not be limited thereto or thereby. The online collectable commerce platform 100 authenticates the traded collectables to increase a reliability of the trade of the collectables. The authentication of the collectables is provided for both online and offline trades. The authentication of the collectables is performed using a unique identifier for each collectable. The online collectable commerce platform 100 issues an authentication certificate of the collectables. The online collectable commerce platform 100 manages the information about the collectables, such as curation information, transaction history information, etc. The information about the collectables are managed in association with the online exhibition room in which collectables corresponding to the information are exhibited. When the collectables are traded, the online collectable commerce platform 100 associates the information about the corresponding collectables with an online exhibition room of a buyer user.

The user terminal 200 means a computer system used by the user. For instance, the user terminal 200 may be a mobile computer system, such as a smartphone, a tablet, a personal digital assistant (PDA), etc. As another example, the user terminal 200 may be a personal computer system, such as a desktop computer, a laptop computer, etc. However, the user terminal 200 should not be limited thereto or thereby, and the user terminal 200 may be an arbitrary computer system that transmits and receives a variety of information to and from the online collectable commerce platform 100 through the network and includes an input unit, an output unit, a processor, a memory, and a communication unit. The user terminal 200 stores a computer program to access the online collectable commerce platform 100 for registering, inquiring, browsing, changing, deleting, and managing the variety of information. The computer program includes various instructions and data.

Referring to FIG. 2, the online collectable commerce platform 100 includes a user interface unit 110, an online exhibition room providing unit 120, a collectable trading intermediate unit 130, a collectable authentication unit 140, a user information management unit 150, and a collectable information management unit 160.

The user interface unit 110 transmits and receives predetermined information to and from the user terminal 200. The user interface unit 110 transmits the information provided from the user terminal 200 to internal components of the online collectable commerce platform 100 and transmits the information provided from the internal components of the online collectable commerce platform 100 to the user terminal 200. That is, the user interface unit 110 serves as a channel of information between the online collectable commerce platform 110 and the user terminal 200.

The online exhibition room providing unit 120 provides the user with the online exhibition room. The online exhibition room providing unit 120 may provide the online exhibition room to only for a certain type of users depending on the type of user. According to another embodiment, the online exhibition room providing unit 120 provides the online exhibition room to a producer user or a collector user. The user may exhibit his or her own collectables in the online exhibition room. The online exhibition room provides a still image or a moving image related to the collectable. The online exhibition room may be provided in two-dimensional (2D) image, three-dimensional (3D) image, an augmented reality (AR) image, or a virtual reality (VR) image, but it should not be limited thereto or thereby. In addition, the online exhibition room may provide caption information including an item name, descriptive information on the collectables, a producer name, and producer activity information associated with the collectables.

The collectable trading intermediate unit 130 intermediates the trade of the collectables. The producer user or the collector user may sell his or her own collectables by using the online exhibition room. The collectable trading intermediate unit 130 provides other users with information about at least one collectable among collectables exhibited in the online exhibition room. According to another embodiment, the user may exhibit the collectables in the online exhibition room while blocking other users from accessing the online exhibition room. That is, the access to the collectables may be permitted only to the owner of the collectables. This is applied to collectables for exhibition. As described later, the collectables exhibited in the online exhibition room are classified into collectables for exhibition and collectables for sale. Information about the collectables for exhibition and information about the collectables for sale are managed differently. For instance, information about the collectables for exhibition include a still image, a moving image, or caption information about the collectables, and the information about the collectables for sale may further include sale information, e.g., price of the collectables, in addition to the information about the collectables for exhibition. The information about the collectables are provided to other users through the online exhibition room. In addition, for the convenience of browsing the information about the collectables, the information about the collectables may be provided to other users in the form of a collectable list rather than the online exhibition room. Further, only a list of the collectables for sale may be provided without providing a list of the collectables for exhibition. The collectable trading intermediate unit 130 intermediates the collectables for sale between the users through the online exhibition room. As described above, the trade of the collectables may be provided at a fixed price or by an auction, but it should not be limited thereto or thereby. The collectable trading intermediate unit 130 may process a transfer of information, a creation of document, and a payment of transaction amount to trade the collectables for sale.

The collectable authentication unit 140 authenticates the collectables being traded. When the trade of the collectable is completed, the collectable authentication unit 140 issues an authentication certificate to the buyer user who has purchased the collectable. For instance, the authentication certificate may be provided to the buyer user as an email body or as an attachment to an email, but it should not be limited thereto or thereby. The authentication certificate includes the unique identifier of the collectables. In addition, the authentication certificate may further include the item name of the collectable, the producer name, an issue date of the authentication certificate, an issue code of the authentication certificate, etc., but it should not be limited thereto or thereby. The collectable authentication unit 140 provides the authentication to the collectables traded in both online and offline. In the case of the online trade, the collectable authentication unit 140 reissues the authentication certificate of the collectable to the buyer user who has recently purchased the collectable through the online platform. In the case of the offline trade, the buyer user may transfer the email to which the authentication certificate is issued or may transmit information about the unique identifier included in the authentication certificate to an offline buyer who has recently purchased the collectable offline The offline buyer may register the collectable to the online collectable commerce platform 100 by using the unique identifier of the collectable after registering as a user in the online collectable commerce platform 100. In this case, the unique identifier is required to be input from the user in a registration request process of the collectable. When the registration of the collectable is requested, the collectable authentication unit 140 requests the buyer user to whom the authentication certificate is issued to verify the offline trade. Then, the collectable authentication unit 140 allows the collectable information management unit 160 described later to additionally and newly associate the information about the collectable with an online exhibition room of the offline buyer user (since the offline buyer user is now registered as the user) depending on the verification approval from the buyer user.

The user information management unit 150 manages user information. The user information management unit 150 stores information about one or more users. The information about user may include, for example, account information of the user, such as an account, a password, etc., profile information of the user, such as a name, a gender, a date of birth, contact information, an email address, an occupation, a place of residence, etc., and other information, such as the type of user, the transaction history information, a reward point, but the information about the user should not be limited thereto or thereby. The information about the user are managed by each user. The user information management unit 150 manages the users after classifying the users into a normal user, the producer user, and the collector user. The normal user corresponds to the type of user who is registered first by default (i.e., a user who does not register a collectable produced by himself/herself or a user who does not own a collectable produced by others through a trade), the producer user corresponds to a user who produces the collectable, and the collector user corresponds to a user who owns one or more collectables. When the normal user registers the collectable, the user information management unit 150 automatically switches the user type of the normal user to the producer user. In addition, when the normal user purchases and owns the collectable, the user information management unit 150 automatically switches the user type of the normal user to the collector user. The user information management unit 150 may receive information about the fact of purchasing the collectable by the normal user from the collectable trading intermediate unit 130 in the case of the online trade or from the collectable authentication unit 140 in the case of the offline trade. Due to the automatic switching of the user type, most of the users are eventually evolved to the collector user if the user is not the producer.

The collectable information management unit 160 manages information about the collectable. The collectable information management unit 160 stores information about one or more collectables. The information about the collectable may include information, such as the still image, the moving image, the caption information, a type of collectable, etc., but the information about the collectable should not be limited thereto or thereby. As described above, the collectable information management unit 160 manages the collectables after classifying the type of the collectable into a collectable for exhibition, a collectable for sale at a fixed price, and a collectable for auction. The type of collectable or the type of sale of the collectable is determined depending on the user's choice. In the case of the collectable for sale, the information about the collectable may further include sale information, such as a price of collectable. In addition, the information about the collectable may further include the curation information and the transaction history information for each collectable. Further, the information about the collectable may further include information about previous owner and information about current owner. Further, the information about the collectable may further include the above-mentioned unique identifier. The information about the collectable are managed for each collectable.

In addition, the collectable information management unit 160 associates the information about the collectable with the online exhibition room in which the collectables are exhibited, i.e., the online exhibition room of the user who owns the collectables. The association between the collectables and the online exhibition room is automatically renewed when the collectables are traded. When the trade of the collectables is completed, the collectable information management unit 160 maintains the association between the information about the collectable and the online exhibition room of the seller user who previously owned the collectable and additionally and newly associates the information about the collectable with the online exhibition room of the buyer user who owns the collectable at present. Accordingly, the curation information and the transaction history information of the collectables are automatically transferred when the collectable is traded. In addition, information about the seller user are added to the previous owner of the collectable, and information about the buyer user are registered to the current owner of the collectable, thereby renewing the information about the owner of the collectable.

In addition, the collectable information management unit 160 may determine at least one variable, e.g., a lowest price, a bidding scheme, a bidding price determination method, etc., for the auction of the collectables based on variable information designed by the user who owns the collectables for auction.

Although not shown in detail, the online collectable commerce platform 100 may be modified to further include some components not shown in FIG. 2 or not to include some components shown in FIG. 2 according to embodiments.

The collectable purchased by the collector user from other users is exhibited in the online exhibition room, the information about the collectable are provided to the other users, and another trade of the collectable between the collector user and the other users may be intermediated by the online collectable platform 100 described above.

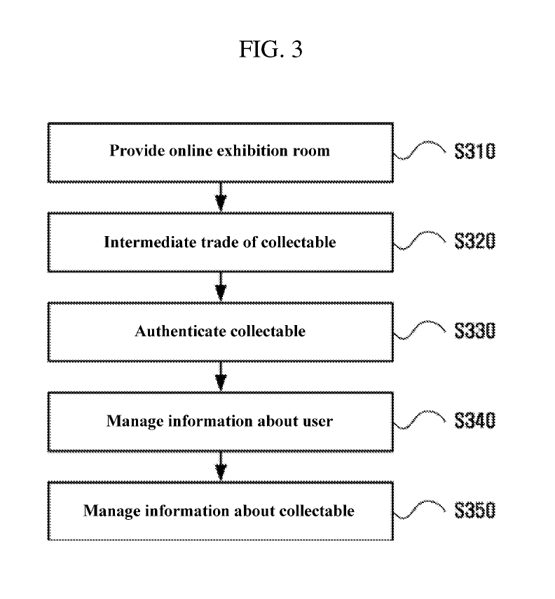

Hereinafter, a method of operating the online collectable commerce platform 100 will be described in detail with reference to FIGS. 3 to 6. For the convenience of explanation, same explanations as those described with reference to FIGS. 1 and 2 will be omitted.

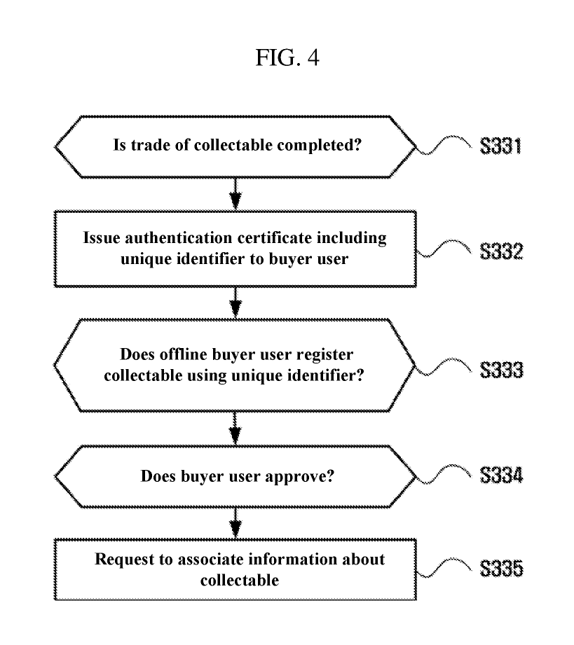

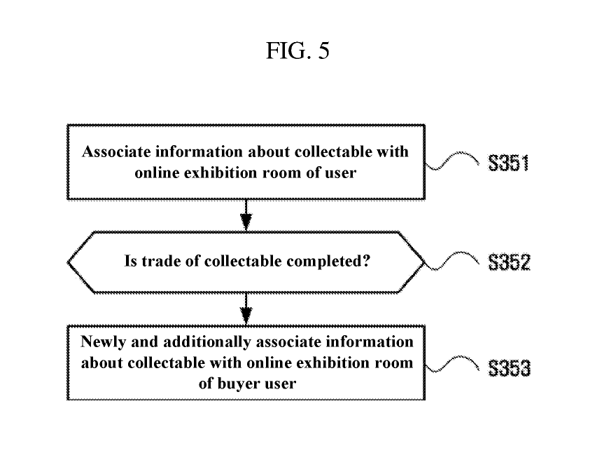

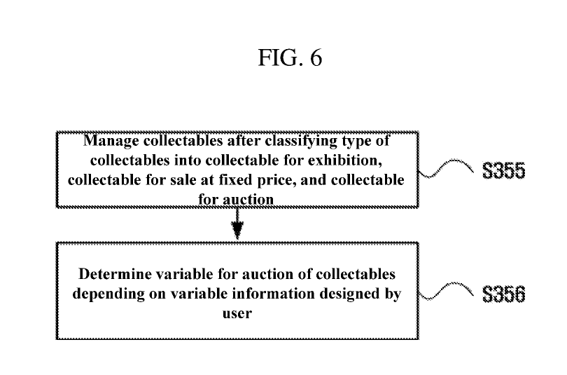

FIG. 3 is a flowchart showing a method for operating the online collectable commerce platform of FIG. 1, FIG. 4 is a flowchart showing a method for authenticating a collectable traded in offline markets using a collectable authentication certificate having a unique identifier as a detailed configuration of an operation of authenticating the collectable of FIG. 3, FIG. 5 is a flowchart showing a method for associating information about a collectable with an online exhibition room as a detailed configuration of an operation of managing the collectable information of FIG. 3, and FIG. 6 is a flowchart showing a method for determining a variable for collectables for auction as a detailed configuration of the operation of managing the collectable information of FIG. 3.

Referring to FIG. 3, in operation S310, the online exhibition room providing unit 120 provides the user with the online exhibition room. The online exhibition room providing unit 120 may provide the online exhibition room to the producer user or the collector user in accordance with the user type.

In operation S320, the collectable trading intermediate unit 130 intermediates the trade of the collectables. The collectable trading intermediate unit 130 provides other users with the information about at least one collectable among the collectables exhibited in the online exhibition room. The information about the collectable may be provided to other users through the online exhibition room or the collectable list. The collectable trading intermediate unit 130 intermediates the trade of the collectable between the users by using the online exhibition room.

In operation S330, the collectable authentication unit 140 authenticates the collectable that is traded. The collectable authentication unit 140 provides the authentication to the collectables traded in both online and offline.

In the case of the online trade, the collectable authentication unit 140 reissues the authentication certificate of the collectable to the buyer user who has recently purchased the collectable through the online platform.

The authentication with respect to the collectable in the case of the offline trade will be described in detail with reference to FIG. 4.

Referring to FIG. 4, in operation S331, the collectable authentication unit 140 determines whether the trade of the collectable is completed. Then, in operation S332, when the trade of the collectable is completed, the collectable authentication unit 140 issues the authentication certificate including the unique identifier of the collectable to the buyer user who purchased the collectable. Next, in operation S333, the collectable authentication unit 140 determines whether the offline buyer user who has recently purchased the collectable in the offline market registers the collectable using the unique identifier of the collectable. Then, in operation S334, when the offline buyer user requests the registration of the collectable, the collectable authentication unit 140 requests the buyer user to whom the authentication certificate of the collectable is issued to verify the offline trade and determines whether the verification on the offline trade is approved by the buyer user. Then, in operation S335, when the buyer user approves, the collectable authentication unit 140 allows the collectable information management unit 160 to newly and additionally associate the information about the collectable with the online exhibition room of the offline buyer user.

In operation S340, the user information management unit 150 manages the user information. The user information management unit 150 stores the information about one or more users. The user information management unit 150 manages the users after classifying the type of the users into the normal user, the producer user, and the collector user. When the normal user purchases and owns the collectable, the user information management unit 150 automatically switches the user type of the normal user to the producer user or the collector user.

In operation S350, the collectable information management unit 160 manages the information about the collectable. The collectable information management unit 160 stores the information about one or more collectables. The information about the collectable may include the curation information and the transaction history information for each collectable. The collectable information management unit 160 manages the collectables after classifying the type of the collectable into the collectable for exhibition, the collectable for sale at a fixed price, and the collectable for auction.

The operation of associating the information about the collectable with the online exhibition room will be described in detail with reference to FIG. 5.

Referring to FIG. 5, in operation S351, the collectable information management unit 160 associates the information about the collectable with the online exhibition room of the user who owns the collectable. Then, in operation S352, the collectable information management unit 160 determines whether the trade of the collectable is completed. In operation S353, when it is determined that the trade of the collectable is completed, the collectable information management unit 160 maintains the association between the information about the collectable and the online exhibition room of the seller user who previously owned the collectable and additionally and newly associates the information about the collectable with the online exhibition room of the buyer user who currently owns the collectable.

The association between the information about the collectable and the online exhibition room of the seller user who previously owned the collectable is maintained, however an indicator that indicates the collectable is sold to another user is displayed in the online exhibition room of the seller user. For instance, a term “sold” may be displayed around the collectable in the online exhibition room as the indicator, but the indicator should not be limited thereto or thereby.

In a case that the buyer user who owns the collectable resells the collectable, the operation of associating the information about the collectable with the online exhibition room is applied substantially the same as above described.

The determination of the variable for the collectable for auction will be described in detail with reference to FIG. 6.

Referring to FIG. 6, in operation 355, the collectable information management unit 160 manages the collectables after classifying the type of the collectable into the collectable for exhibition, the collectable for sale at a fixed price, and the collectable for auction. In operation S356, the collectable information management unit 160 determines at least one variable for the collectables for auction based on the variable information designed by the user who owns the collectables for auction.

Although not shown in detail, the method of operating the online collectable commerce platform 100 may be modified to further include some operations not shown in FIGS. 3 to 6 or not to include some operations shown in FIGS. 3 to 6 according to embodiments.

In addition, the method of operating the online collectable commerce platform 100 may be modified to be performed in a different order from the order shown in FIGS. 3 to 6. Some operations shown in FIGS. 3 to 6 may be substantially simultaneously performed with another operation.

When the collectable exhibited in the online exhibition room is selected, a page of detailed information on the collectable is provided. The detailed information page of the collectable includes the still image, the moving image, and the caption information about the collectables, the sale information about the collectables, e.g., the price of the collectables, the curation information, and the transaction history information. In addition, the detailed information page may further include the owner information about the collectables.

As described above, the collectable sold to another user may be exhibited in the online exhibition room of the previous owner, and when the collectable is selected, the current owner information about the collectable may be checked in the detailed information page of the collectable.

According to the online collectable commerce platform 100 and the operating method of the online collectable commerce platform 100, since the online exhibition room is provided to the users without charge, a large number of collectables may be exhibited and viewed without time and space constraints. Most of the normal users may be eventually evolved to the collector user and may exhibit their own collectables in the online exhibition room. A potential buyer may search for various producers or collectors and their collectables through the online exhibition room. The user who purchases the collectable may resell the collectable through the online exhibition room right after purchasing the collectable without any extra effort. Accordingly, the resale of the collectables may be activated continuously. In addition, since the authentication certificate for the online and offline trades is provided, the reliability of the trade of the collectables may be improved. Thus, a large number of producers of the collectables, which are in various categories at a variety of price ranges and with lack of publicity, may be successively connected to a large number of potential collectors looking for the producers, and thus the collectables in various categories at a variety of price ranges, which are produced by various producers, may be traded.

In particular, according to the online collectable commerce platform 100 and the operating method of the online collectable commerce platform 100, a second-hand transaction of the collectables collected by the collector is activated. In detail, when the normal user purchases the collectable, the normal user is switched to the collector, i.e., a potential seller, the online exhibition room is provided to the collector, and the information about the collectable is newly associated with the online exhibition room of the collector to transfer the information about the collectable to the online exhibition room of the collector. Accordingly, the reselling (the fixed price sale or the auction) of the collectable may become possible right after the collector purchases the collectable. In addition, although the collectable registered to the online collectable commerce platform 100 is traded again in the offline market, the information about the collectable may be continuously and cumulatively managed in the online collectable commerce platform 100 by using the unique identifier, and the collectable may be re-registered to the online collectable commerce platform 100 by the offline buyer. Accordingly, the collectable does not leak to the offline market.

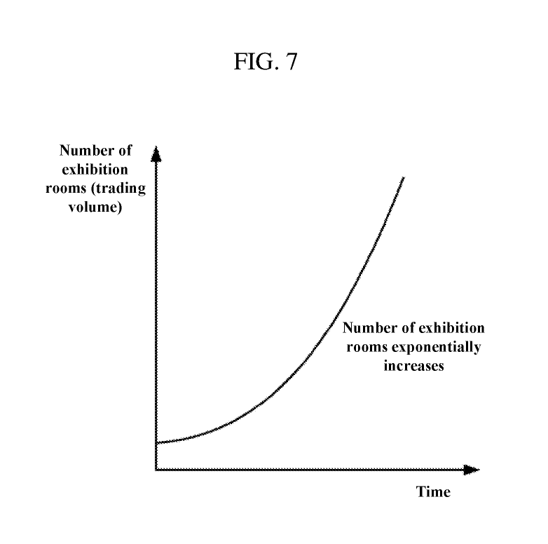

FIG. 7 is a graph showing the number of exhibition rooms, which exponentially increases, as a function of a time. The number of second-hand transactions of the collectable increases as the number of the exhibition rooms increases. For instance, in a case that one thousand producers register ten collectables and five buyers appear in the online exhibition room of each producer, the number of the online exhibition rooms rapidly increases from 1000 to 6000, and thus the trade of the collectable also increases together with the increase of the number of the online exhibition rooms. That is, a massive second-hand market is formed.

In some embodiments, the above-discussed method of FIG. 3-6, according to this disclosure, are implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for the present disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for implementing the message processing method according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

What is claimed is:

1. An online collectable commerce platform comprising:
a user interface unit configured to be connected to a user terminal through a network and to transmit and receive predetermined information to and from the user terminal;
an online exhibition room providing unit configured to provide an online exhibition room to a producer user or a collector user for an exhibition of collectables owned by the producer user or the collector user in the online exhibition room;
a collectable trading intermediate unit configured to provide another user with information about at least one collectable for sale among the collectables exhibited in the online exhibition room and intermediate a trade of the at least one collectable for sale between a plurality of users;
a user information management unit configured to store information about one or more users, manage the users after classifying a type of the users into a normal user, the producer user, and the collector user, and switch the type of the normal user to the collector user when the normal user purchases the collectable for sale; and
a collectable information management unit configured to store information about one or more collectables and manage curation information and transaction history information for each collectable as the information about the collectables,
wherein the collectable for sale, which is purchased by the collector user from another user, is exhibited in the online exhibition room, the information about the collectable for sale are provided to another user, and a resale of the collectable for sale is intermediated between the collector user and another user.

2. The online collectable commerce platform of claim 1, wherein the collectable information management unit is configured to associate the information about the collectable with an online exhibition room of a user who owns the collectable, maintain an association between the information about the collectable for sale with an online exhibition room of a seller user who owned the collectable for sale when the collectable for sale is traded, and additionally and newly associate the information about the collectable for sale with an online exhibition room of a buyer user who owns the collectable for sale.

3. The online collectable commerce platform of claim 2, further comprising a collectable authentication unit, wherein the information about the collectable comprises a unique identifier for each collectable, the collectable authentication unit is configured to issue an authentication certificate including the unique identifier of the collectable for sale to the buyer user of the collectable for sale when the trade of the collectable is completed and, to allow the collectable information management unit to maintain the association between the information about the collectable for sale with the online exhibition room of the buyer user and additionally and newly associate the information about the collectable for sale with an online exhibition room of the offline buyer user, when an offline buyer user who has purchased the collectable for sale offline registers the collectable for sale using the unique identifier of the collectable for sale, depending on an approval of the buyer user of the collectable for sale to whom the authentication certificate is issued.

4. The online collectable commerce platform of claim 2, wherein the collectable information management unit is configured to manage the collectables after classifying a type of the collectables into a collectable for exhibition, a collectable for sale at a fixed price, and a collectable for auction in accordance with a selection of the user who owns the collectable and to determine at least one variable for the auction of the collectable based on variable information designed by a user who owns the collectable for auction.

5. A method of operating an online collectable commerce platform connected to a user terminal through a network to transmit and receive predetermined information to and from the user terminal, comprising:
providing an online exhibition room to a producer user or a collector user for an exhibition of collectables owned by the producer user or the collector user in the online exhibition room;
providing another user with information about at least one collectable for sale among the collectables exhibited in the online exhibition room and intermediate a trade of the at least one collectable for sale between a plurality of users;
storing information about one or more users and managing the users after classifying a type of the users into a normal user, the producer user, and the collector user to switch the type of the normal user to the collector user when the normal user purchases the collectable for sale; and
storing information about one or more collectables to manage curation information and transaction history information for each collectable as the information about the collectables,
wherein the collectable for sale, which is purchased by the collector user from another user, is exhibited in the online exhibition room, the information about the collectable for sale are provided to another user, and a resale of the collectable for sale is intermediated between the collector user and another user.

6. The method of claim 5, wherein the managing the information about the collectable comprises:
associating the information about the collectable with an online exhibition room of a user who owns the collectable;
maintaining an association between the information about the collectable for sale with an online exhibition room of a seller user who owned the collectable for sale when the collectable for sale is traded; and
additionally and newly associating the information about the collectable for sale with an online exhibition room of a buyer user who owns the collectable for sale.

7. The method of claim 6, further comprising authenticating the collectable, wherein the information about the collectable comprises a unique identifier for each collectable, and the authenticating the collectable comprises:
issuing an authentication certificate including the unique identifier of the collectable for sale to the buyer user of the collectable for sale when the trade of the collectable is completed; and
maintaining the association between the information about the collectable for sale with the online exhibition room of the buyer user and additionally and newly associating the information about the collectable for sale with an online exhibition room of the offline buyer user, when an offline buyer user who has purchased the collectable for sale offline registers the collectable for sale using the unique identifier of the collectable for sale, depending on an approval of the buyer user of the collectable for sale to whom the authentication certificate is issued.

8. The method of claim 6, wherein the managing the information about the collectable further comprises:
managing the collectables after classifying a type of the collectables into a collectable for exhibition, a collectable for sale at a fixed price, and a collectable for auction in accordance with a selection of the user who owns the collectable; and
determining at least one variable for the auction of the collectable based on variable information designed by a user who owns the collectable for auction.

9. A computer-readable recording medium storing a computer program executing the method according to claim 5.

10. A computer program stored in a medium for executing the method according to claim 5 after being installed in a computer.
